(19) United States
(12) Patent Application Publication
(10) Pub. No.: US 2024/0428983 A1
(43) Pub. Date: Dec. 26, 2024

(54) COIL COMPONENT, METHOD OF BONDING WIRE, AND METHOD OF MANUFACTURING COIL COMPONENT

(71) Applicant: Murata Manufacturing Co., Ltd., Kyoto-fu (JP)

(72) Inventor: Wataru DOI, Nagaokakyo-shi (JP)

(73) Assignee: Murata Manufacturing Co., Ltd., Kyoto-fu (JP)

(21) Appl. No.: 18/748,690

(22) Filed: Jun. 20, 2024

(30) Foreign Application Priority Data
Jun. 26, 2023 (JP) 2023-104337

(51) Int. Cl. H01F 27/28; B23K 26/20; B23K 101/38; H01F 27/32; H01F 41/10

(52) U.S. Cl. CPC H01F 27/2828; B23K 26/20; H01F 27/323; H01F 41/10; B23K 2101/38

(57) ABSTRACT

A coil component includes a core, a wire, and outer electrodes. The core includes a winding core and a pair of flanges. A first axis orthogonally intersects a central axis. A first positive direction is a direction directed toward one side along the first axis. A first negative direction is directed oppositely to the first positive direction. Each outer electrode covers a surface of each flange, the surface facing in the first positive direction. The wire includes a body portion wound around the winding core and a bonded portion at each end of the wire and coupled to each outer electrode. In a cross section that orthogonally intersects the central axis and includes the bonded portion, the end of the bonded portion facing in the first negative direction is further in the first negative direction from the end of the outer electrode facing in the first positive direction.

### CROSS-REFERENCE TO RELATED APPLICATION

This application claims benefit of priority to Japanese Patent Application No. 2023-104337, filed Jun. 26, 2023, the entire content of which is incorporated herein by reference.

### BACKGROUND

### Technical Field

The present disclosure relates to a coil component, to a method of bonding a wire, and to a method of manufacturing the coil component.

### Background Art

The coil component described in Japanese Unexamined Patent Application Publication No. 2005-294307 includes a core. The core further includes a winding core and two flanges. The winding core is shaped like a quadrangular prism. The two flanges are joined to respective opposite ends of the winding core. Each flange projects outward from surfaces of the winding core in directions orthogonal to the central axis of the winding core. The coil component also includes a first outer electrode and a second outer electrode. The first outer electrode is positioned on the top surface of one flange. The second outer electrode is positioned on the top surface of the other flange. The coil component includes a wire. The wire is a covered conducting wire. The wire is wound around the winding core. A first end of the wire is bonded to the first outer electrode using thermocompression bonding. A second end of the wire is bonded to the second outer electrode using the thermocompression bonding. The thermocompression bonding is performed with a heater chip pressed against the wire.

### SUMMARY

In the coil component described in Japanese Unexamined Patent Application Publication No. 2005-294307, when each end of the wire is bonded to the outer electrode, the end of the wire is flattened and thinned due to the application of the heat and pressure. External forces tend to concentrate on the thinned portion of the wire, leading to breakage of the wire.

According to an aspect of the disclosure, a coil component includes a core that includes a column-like winding core having a central axis and a pair of flanges joined to respective opposite ends of the winding core in an axial direction of the winding core; a wire wound around the winding core; and an outer electrode that covers an outer surface of each flange of the pair of flanges. A first axis is defined as an axis orthogonally intersecting the central axis. A positive direction is defined as a direction directed toward one side along the first axis, and a negative direction is defined as the direction directed oppositely to the positive direction. Each flange projects outward in the positive direction from an outer surface of the winding core. The outer electrode covers the outer surface of each flange facing in the positive direction. The wire includes a body portion wound around the winding core and a bonded portion positioned at each end of the wire and coupled to the outer electrode. A cross section of each flange is taken so as to orthogonally intersect the central axis and to include the bonded portion. In the cross section, an end of the bonded portion facing in the negative direction is positioned further in the negative direction from an end of the outer electrode facing in the positive direction. In the cross section, a length along the first axis between the end of the bonded portion facing in the negative direction and an end of the bonded portion facing in the positive direction is greater than a diameter of the body portion.

According to another aspect of the disclosure, a method of bonding a wire includes a ball forming step of forming a ball portion by melting the wire at each end of the wire, the ball portion having a diameter greater than that of a body portion of the wire before melting the wire; and a bonding step of forming a bonded portion at each end of the wire. The bonded portion is bonded to an outer electrode that covers an outer surface of a core, in such a manner that the ball portion is irradiated with a laser beam while the ball portion is in contact with the outer electrode.

According to another aspect of the disclosure, a method of manufacturing a coil component includes a preparation step of preparing a core that includes a column-like winding core having a central axis, a pair of flanges joined to respective opposite ends of the winding core in an axial direction of the winding core, and an outer electrode that covers an outer surface of each flange of the pair of flanges; a winding step of winding a wire around the winding core; a ball forming step of forming a ball portion by melting the wire at each end of the wire, the ball portion having a diameter greater than that of a body portion of the wire before melting the wire; and a bonding step of forming a bonded portion at each end of the wire. The bonded portion is bonded to an outer electrode, in such a manner that the ball portion is irradiated with a laser beam while the ball portion is in contact with the outer electrode.

According to the above configuration, the thickness of each bonded portion of the wire is greater than the diameter of the body portion. As a result, the wire does not break easily at the boundary portion between the body portion and each bonded portion even if external forces act more or less on the bonded portion.

Accordingly, the breakage of the wire at the bonded portion and at the boundary between the bonded portion and the body portion is prevented.

### BRIEF DESCRIPTION OF THE DRAWINGS

FIG. 1 is a perspective view illustrating a coil component;

FIG. 2 is an enlarged view illustrating the vicinity of a second bonded portion as viewed in the first negative direction;

FIG. 3 is a cross-sectional view taken along line 3-3 in FIG. 2.

FIG. 4 is a view for explanation of a method of manufacturing the coil component;

FIG. 5 is a view for explanation of the method of manufacturing the coil component;

FIG. 6 is a view for explanation of the method of manufacturing the coil component;

FIG. 7 is a view for explanation of the method of manufacturing the coil component;

FIG. 8 is a view for explanation of the method of manufacturing the coil component;

FIG. 9 is a view for explanation of the method of manufacturing the coil component;

FIG. 10 is a view for explanation of the method of manufacturing the coil component;

FIG. 11 is a view for explanation of the method of manufacturing the coil component;

FIG. 12 is a view for explanation of the method of manufacturing the coil component;

FIG. 13 is a view for explanation of the method of manufacturing the coil component; and

FIG. 14 is a cross-sectional view illustrating a coil component according to a modification example.

### DETAILED DESCRIPTION

An embodiment of a coil component will be described with reference to the drawings. Note that elements in the drawings may be illustrated in an exaggerated manner to facilitate better understanding. Dimensional relations of elements in the drawings may be different from those of actual elements or may be different in different drawings.

### Overall Structure

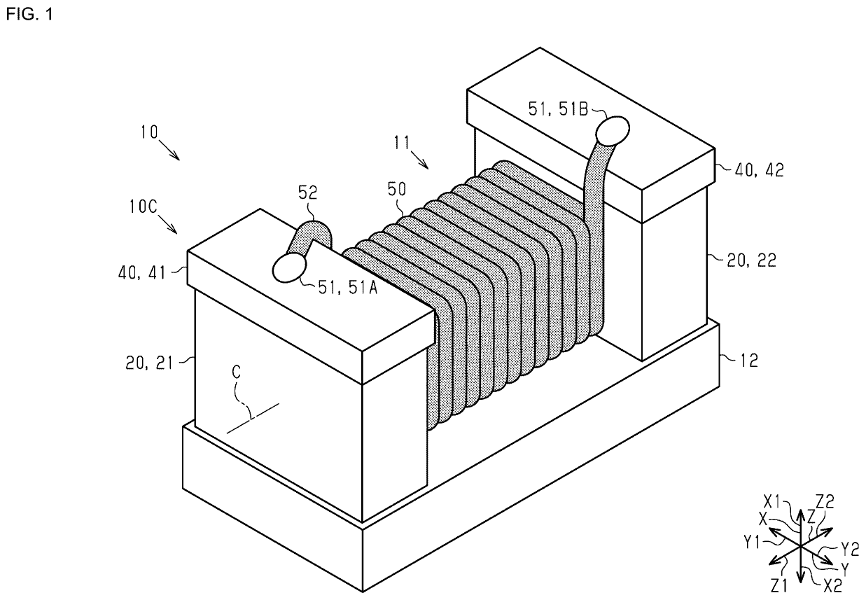

As illustrated in FIG. 1, a coil component 10 includes a core 10C and a top plate 12. The core 10C includes a column-like winding core 11, a first flange 21, and a second flange 22. Note that the first flange 21 and the second flange 22 may be generically referred to as “flanges 20” where it is not necessary to differentiate the first flange 21 from the second flange 22.

The winding core 11 is shaped like a quadrangular prism. A cross section of the winding core 11 that orthogonally intersects the central axis C of the winding core 11 is shaped like a rectangle. Note that the term “rectangle” as used herein may be a polygon having four sides and shaped substantially like a rectangle, including a rectangle with a corner or corners being rounded. The winding core 11 is made of a non-conductive material. More specifically, the winding core 11 is made of, for example, Ni—Zn based ferrite, alumina, synthetic resin, or a mixture thereof.

A first axis X is defined as an axis that extends orthogonally to the central axis C of the winding core 11. In the present embodiment, the first axis X extends parallel to two of the four sides of the winding core 11 when the winding core 11 is viewed along the central axis C. In addition, a second axis Y is defined as an axis that orthogonally intersects both of the first axis X and the central axis C. In the present embodiment, the second axis Y extends parallel to the other two of the four sides of the winding core 11 when the winding core 11 is viewed along the central axis C. A third axis Z is defined as an axis that extends parallel to the central axis C. A first positive direction X1 is defined as a direction directed toward one side along the first axis X, and a first negative direction X2 is defined as the direction directed oppositely to the first positive direction X1. Similarly, a second positive direction Y1 is defined as a direction directed toward one side along the second axis Y, and a second negative direction Y2 is defined as the direction directed oppositely to the second positive direction Y1. In addition, a third positive direction Z1 is defined as a direction directed toward one side along the third axis Z, and a third negative direction Z2 is defined as the direction directed oppositely to the third positive direction Z1.

As illustrated in FIG. 1, the first flange 21 is connected to a first end portion of the winding core 11, the first end portion facing in the third positive direction Z1. The first flange 21 is shaped like a flat quadrangular plate. The thickness direction of the first flange 21 extends along the third axis Z. As viewed along the third axis Z, the sides of the first flange 21 extend parallel to respective sides of the winding core 11. The first flange 21 projects outward from respective outer surfaces of the winding core 11 in directions along the first axis X and the second axis Y. In other words, the first flange 21 projects outward also in the first positive direction X1 from an outer surface of the winding core 11.

The second flange 22 is connected to a second end portion of the winding core 11, the second end portion facing in the third negative direction Z2. The shape of the second flange 22 and the shape of the first flange 21 are in plane symmetry. In other words, the second flange 22 is shaped like a quadrangular plate. The second flange 22 projects outward from respective outer surfaces of the winding core 11 in directions along the first axis X and the second axis Y. In other words, the second flange 22 projects outward also in the first positive direction X1 from an outer surface of the winding core 11.

The first flange 21 and the second flange 22 are made of the same material as that of the winding core 11. The first flange 21 and the second flange 22 are formed integrally with the winding core 11. The top plate 12 is a flat rectangular plate. The thickness direction of the top plate 12 extends along the first axis X. The long sides of the top plate 12 extend parallel to the third axis Z. The short sides of the top plate 12 extend parallel to the second axis Y. The top plate 12 is positioned away from the core 10C in the first negative direction X2. The top plate 12 is connected to respective surfaces of the first flange 21 and the second flange 22, the surfaces facing in the first negative direction X2. In other words, the top plate 12 is suspended between the first flange 21 and the second flange 22. The top plate 12 is made of the same material as that of the winding core 11.

The coil component 10 includes a first outer electrode 41 and a second outer electrode 42. The first outer electrode 41 entirely covers the surface of the first flange 21 facing in the first positive direction X1. The second outer electrode 42 entirely covers the surface of the second flange 22 facing in the first positive direction X1. Note that the first outer electrode 41 and the second outer electrode 42 may be generically referred to as “outer electrodes 40” where it is not necessary to differentiate the first outer electrode 41 from the second outer electrode 42.

As illustrated in FIG. 3, each outer electrode 40 includes a primary coat L0, a first layer L1, a second layer L2, and a third layer L3. The primary coat L0 is positioned further in the first negative direction X2 than any other layer of the outer electrode 40. In other words, the primary coat L0 is in contact with the surface of each flange 20 facing in the first positive direction X1. The primary coat L0 contains silver (Ag). The first layer L1 covers the surface of the primary coat L0 facing in the first positive direction X1. The first layer L1 contains nickel (Ni). The second layer L2 covers the surface of the first layer L1 facing in the first positive direction X1. The second layer L2 contains copper (Cu).

The third layer L3 covers the surface of the second layer L2 facing in the first positive direction X1. In other words, the third layer L3 is the outermost layer among the layers of the outer electrodes 40. Accordingly, the primary coat L0, the first layer L1, and the second layer L2 are inner layers, and the third layer L3 is the outer layer positioned outside the inner layer, in other words, positioned opposite to the surface of the flange 20. The third layer L3 contains tin (Sn). The first layer L1, the second layer L2, and the third layer L3 are layers plated on the primary coat L0. Note that FIG. 1 illustrates these layers as one integral body disposed on each outer electrode 40.

### Wire

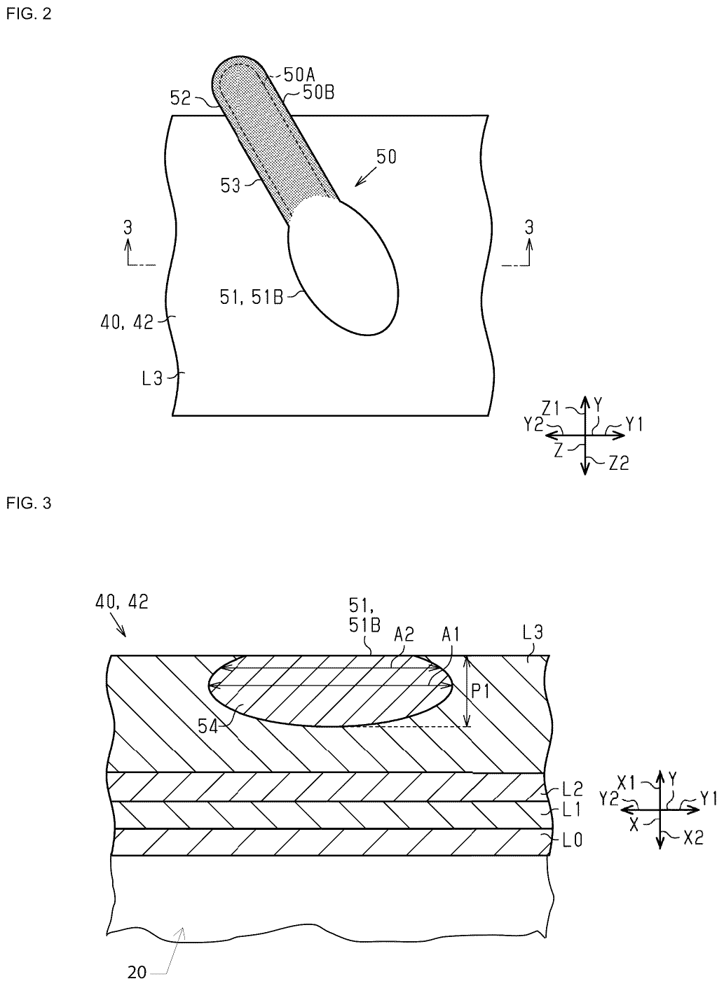

As illustrated in FIG. 1, the coil component 10 includes a wire 50 wound around the winding core 11. As illustrated in FIG. 2, the wire 50 includes a conductor 50A and an insulating coating 50B. The conductor 50A is elongated as a wire. For example, the conductor 50A is made of copper (Cu). In the present embodiment, the diameter of the conductor 50A is approximately 10 μm. The insulating coating 50B covers the peripheral surface of the conductor 50A. The insulating coating 50B is made of a synthetic resin, such as polyurethane or polyamide-imide. In the present embodiment, the thickness of the insulating coating 50B is approximately 2.5 μm. The cross section of the wire 50 taken in the direction orthogonal to the extending direction of the wire 50 has a substantially circular shape.

As illustrated in FIG. 1, the wire 50 includes a first bonded portion 51A, a second bonded portion 51B, and a body portion 52. Note that the first bonded portion 51A and the second bonded portion 51B may be generically referred to as “bonded portions 51” where it is not necessary to differentiate the first bonded portion 51A from the second bonded portion 51B. The first bonded portion 51A is positioned at the end of the wire 50 facing in the third positive direction Z1. The first bonded portion 51A is coupled to the first outer electrode 41. The second bonded portion 51B is positioned at the end of the wire 50 facing in the third negative direction Z2. The second bonded portion 51B is coupled to the second outer electrode 42. Each bonded portion 51 includes the conductor 50A only and does not include the insulating coating 50B. At least part of the boundary portion between the bonded portion 51 and the third layer L3 is made of Cu—Sn alloy. Note that the above statement “each bonded portion 51 includes the conductor 50A only” allows the bonded portion 51 to have a slight trace of the insulating coating 50B. More specifically, when the bonded portion 51 is observed as viewed in the first negative direction X2, the bonded portion 51 is determined to include “the conductor 50A only” if the conductor 50A is present at 97% or more

The body portion 52 is the portion of the wire 50 excluding the bonded portions 51. The body portion 52 is wound around the winding core 11. The body portion 52 includes the conductor 50A and the insulating coating 50B. The diameter of the body portion 52 is approximately 15 μm on the basis of the above-described dimensional relationship of the conductor 50A and the insulating coating 50B.

### Provisional Fixation Portion of Wire

As illustrated in FIG. 2, the body portion 52 of the wire 50 has a provisional fixation portion 53. The provisional fixation portion 53 is positioned closer than the second bonded portion 51B to the winding core 11. The provisional fixation portion 53 is positioned so as to adjoin the second bonded portion 51B in the extension direction of the wire 50.

The provisional fixation portion 53 is bonded to the third layer L3 of the second outer electrode 42. More specifically, the end of the provisional fixation portion 53 facing in the first negative direction X2 is positioned further in the first negative direction X2 from the end of the third layer L3 facing in the first positive direction X1. In other words, the provisional fixation portion 53 having the insulating coating 50B is buried at least partially in the second outer electrode 42.

### Dimensional Relationship Between Outer Electrode and Wire

The following describes the dimensional relationship between each bonded portion 51 and the corresponding outer electrode 40. The following description focuses on the dimensional relationship between the second bonded portion 51B and the second outer electrode 42, which applies also to the dimensional relationship between the first bonded portion 51A and the first outer electrode 41.

As illustrated in FIG. 3, a cross section (otherwise referred to as a “specific cross section”) is taken so as to orthogonally intersect the central axis C and to include the second bonded portion 51B. The second bonded portion 51B is buried in the second outer electrode 42. In other words, the end of second bonded portion 51B facing in the first negative direction X2 is positioned further in the first negative direction X2 from the end of the second outer electrode 42 facing in the first positive direction X1. Note that the entire second bonded portion 51B is buried in the second outer electrode 42. More specifically, in the direction parallel to the first axis X, the end of the second bonded portion 51B facing in the first positive direction X1 is positioned at the end of the second outer electrode 42 facing in the first positive direction X1.

The end surface of the second bonded portion 51B facing in the first positive direction X1 is a flat surface extending parallel to the second axis Y and the central axis C. In addition, the end surface of the second bonded portion 51B facing in the first positive direction X1 is substantially flush with the end surface of the second outer electrode 42 facing in the first positive direction X1.

Note that the end of the second outer electrode 42 facing in the first positive direction X1 can be determined by using an electron microscope and processing an outline image of the second outer electrode 42 on the specific cross section. In the outline image, a point positioned furthest in the first positive direction X1 can be determined as the end of the second outer electrode 42 facing in the first positive direction X1.

In the above-described specific cross section, the end of the second bonded portion 51B facing in the first negative direction X2 is positioned further in the first positive direction X1 from the end of the second layer L2 facing in the first positive direction X1. In other words, the second bonded portion 51B is positioned in the third layer L3 and does not reach the second layer L2.

In the specific cross section, the length P1 between the end of the second bonded portion 51B facing in the first negative direction X2 and the end of the second bonded portion 51B facing in the first positive direction X1 is approximately 21 μm when the length P1 is measured along the first axis X. Accordingly, the length P1 along the first axis X between the end of the second bonded portion 51B facing in the first negative direction X2 and the end of the second bonded portion 51B facing in the first positive direction X1 is greater than the diameter of the body portion 52.

In the specific cross section, a buried portion 54 refers to a portion of the second bonded portion 51B that is positioned further in the first negative direction X2 from the end of the second outer electrode 42 facing in the first positive direction X1. In the present embodiment, the buried portion 54 corresponds to a portion of the second bonded portion 51B excluding the end surface facing in the first positive direction X1 in the specific cross section. In the specific cross section, a first length A1 refers to a maximum length of the buried portion 54 along the second axis Y. The first length A1 is approximately 63 μm. Accordingly, the first length A1 is greater than the diameter of the body portion 52.

A second length A2 refers to the length of the buried portion 54 along the second axis Y at a position further in the first positive direction X1 from where the first length A1 is taken. The second length A2 is smaller than the first length A1.

### Method of Manufacturing Coil Component

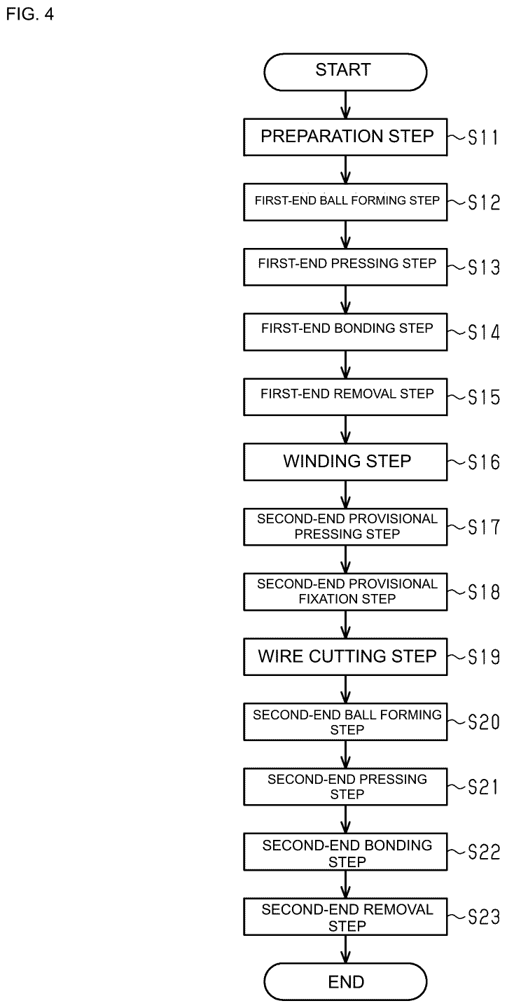

As illustrated in FIG. 4, a method of manufacturing the coil component 10 includes a preparation step S11, a first-end ball forming step S12, a first-end pressing step S13, a first-end bonding step S14, a first-end removal step S15, and a winding step S16. The method of manufacturing the coil component 10 also includes a second-end provisional pressing step S17, a second-end provisional fixation step S18, a wire cutting step S19, a second-end ball forming step S20, a second-end pressing step S21, a second-end bonding step S22, and a second-end removal step S23.

The steps from the first-end ball forming step S12 to the first-end removal step S15 and the steps from the second-end provisional pressing step S17 to the second-end removal step S23 relate to a method of bonding the wire 50.

The preparation step S11 is performed first. In the preparation step S11, the core 10C with the outer electrodes 40 formed therein is prepared. The core 10C is formed by mixing a Ni—Zn based ferrite powder with a synthetic resin binder, press-forming the mixture to produce a green compact, and sintering the green compact. This produces the core 10C having the winding core 11, the first flange 21, and the second flange 22. A conductive paste containing silver (Ag) is applied to a surface of the first flange 21 of the core 10C, the surface facing in the first positive direction X1. The paste is bonded using an evaporation method to form the primary coat L0. The first layer L1, the second layer L2, and the third layer L3 are formed on the primary coat L0 using electroplating. The first outer electrode 41 is thus formed. Similarly, the second outer electrode 42 is formed on the surface of the second flange 22, the surface facing in the first positive direction X1. Subsequently, the core 10C with the outer electrodes 40 formed therein is put between a pair of rotating chucks RC with the flanges 20 being held by the rotating chucks RC. Accordingly, the core 10C held by the rotating chucks RC can rotate about the central axis C.

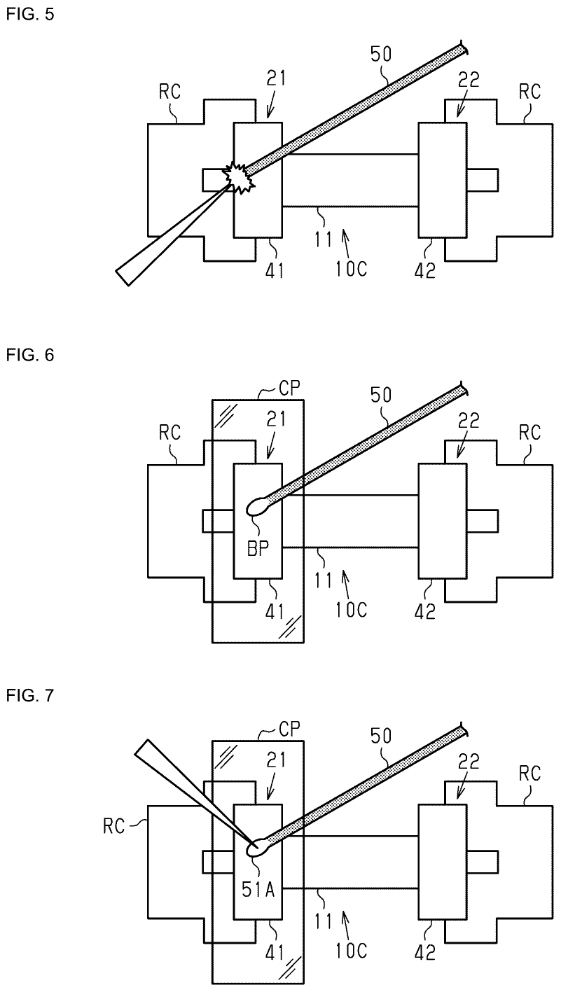

Next, the first-end ball forming step S12 is performed. Before the first-end ball forming step S12, the first end portion of the wire 50 has the conductor 50A and the insulating coating 50B. In the first-end ball forming step S12, as illustrated in FIG. 5, the first end portion of the wire 50 is irradiated with a laser beam. The insulating coating 50B of the portion irradiated with the laser beam is melted to expose the conductor 50A. Subsequently, as illustrated in FIG. 6, the conductor 50A of the irradiated portion is also melted to form a sphere-like ball portion BP having a diameter greater than the diameter of the body portion 52. In this state, part of the insulating coating 50B may remain on the surface of the ball portion BP.

Next, the first-end pressing step S13 is performed. In the first-end pressing step S13, as illustrated in FIG. 6, the ball portion BP is pressed against the first outer electrode 41 using a transmissive member CP made of a laser-transmissive material. More specifically, the ball portion BP is held between the transmissive member CP and the first outer electrode 41. It is sufficient that the material of the transmissive member CP be a laser-transmissive material, which is, for example, borosilicate glass or sapphire glass. When the ball portion BP is pressed against the transmissive member CP, the insulating coating 50B remaining on the ball portion BP sticks to the transmissive member CP.

Next, the first-end bonding step S14 is performed. In the first-end bonding step S14, as illustrated in FIG. 7, the ball portion BP is irradiated with a laser beam from the side of the transmissive member CP while the ball portion BP is held between the transmissive member CP and the first outer electrode 41. In this state, the ball portion BP is in contact with the first outer electrode 41. The first bonded portion 51A is thereby formed at the first end of the wire 50 and is joined to the first outer electrode 41. The ball portion BP is buried in a melted or softened portion of the third layer L3 by the pressing force of the transmissive member CP, thereby forming the buried portion 54. The pressing force of the transmissive member CP flattens a surface of the first bonded portion 51A, the surface facing in the first positive direction X1.

Next, the first-end removal step S15 is performed. In the first-end removal step S15, the transmissive member CP is removed from the wire 50. In the first-end removal step S15, the residual insulating coating 50B remaining on the ball portion BP is removed from the wire 50 together with the transmissive member CP.

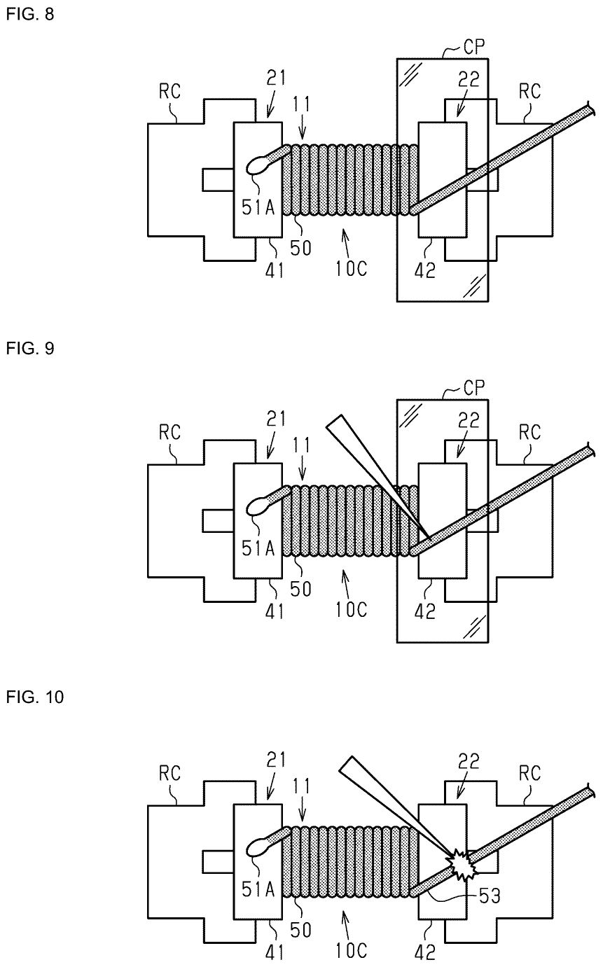

Next, the winding step S16 is performed. In the winding step S16, the wire 50 is wound around the winding core 11 while the core 10C is rotated together with the rotating chucks RC about the central axis C. Next, the second-end provisional pressing step S17 is performed. In the second-end provisional pressing step S17, as illustrated in FIG. 8, the wire 50 is taken out from the wound portion on the winding core 11 and is positioned on the second outer electrode 42. The wire 50 is subsequently held between the transmissive member CP and the second outer electrode 42. The wire 50 is thereby positioned provisionally.

Next, the second-end provisional fixation step S18 is performed. In the second-end provisional fixation step S18, as illustrated in FIG. 9, a provisional fixation area on the second outer electrode 42 is irradiated with a laser beam from the side of the transmissive member CP. The provisional fixation portion 53 of the wire 50, which is positioned closer than the second bonded portion 51B to the winding core 11, is bonded to the provisional fixation area on the second outer electrode 42. The third layer L3 melts in the provisional fixation area irradiated with the laser beam. The provisional fixation portion 53 of the wire 50 is pressed against the melted provisional fixation area, and the provisional fixation portion 53 is buried in, and bonded to, the provisional fixation area. The provisional fixation portion 53 is thus formed in the body portion 52 of the wire 50. Note that in the second-end provisional fixation step S18, the third layer L3 of the second outer electrode 42 is irradiated with the laser beam and the wire 50 is not directly exposed to the laser beam. The irradiation of the laser beam is performed such that the irradiation proceeds in the extending direction of the wire 50. The insulating coating 50B does not melt and remains in the provisional fixation portion 53.

Next, the wire cutting step S19 is performed. In the wire cutting step S19, as illustrated in FIG. 10, the transmissive member CP is first removed from the wire 50. Subsequently, the laser beam is shined on a portion of the wire 50 that is positioned opposite to the winding core 11 with respect to the provisional fixation portion 53 in the extension direction of the wire 50. The wire 50 is thereby cut, and the second end portion is formed.

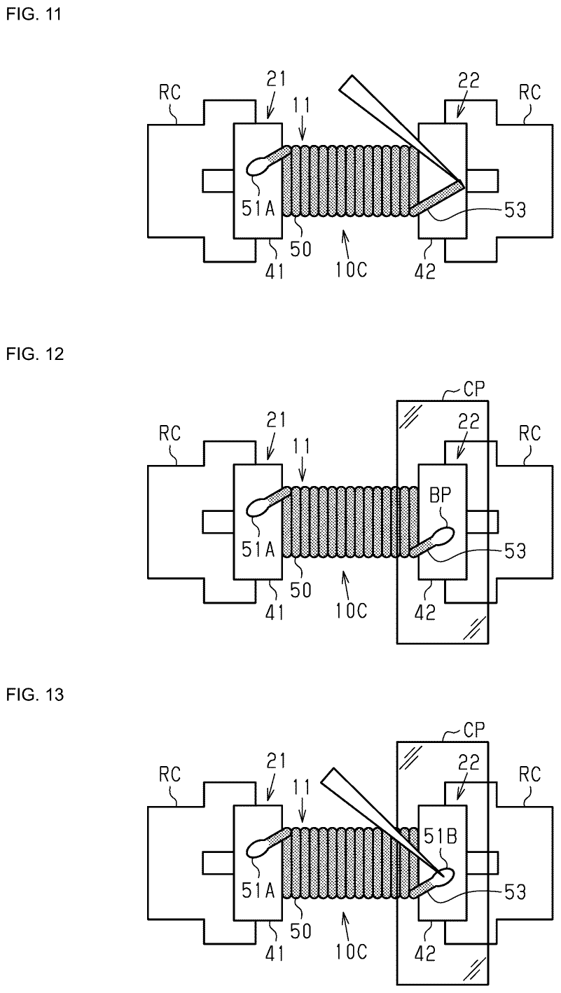

Next, the second-end ball forming step S20 is performed. In the second-end ball forming step S20, as illustrated in FIG. 11, the second end portion of the wire 50 is irradiated with a laser beam. The laser beam melts the insulating coating 50B and exposes the conductor 50A. Subsequently, the irradiated portion of the conductor 50A is also melted to form a sphere-like ball portion BP having a diameter greater than the diameter of the body portion 52. In this state, a part of the insulating coating 50B may remain on the surface of the ball portion BP.

Next, the second-end pressing step S21 is performed. In the second-end pressing step S21, as illustrated in FIG. 12, the ball portion BP is pressed against the second outer electrode 42 using the transmissive member CP. More specifically, the ball portion BP is held between the transmissive member CP and the second outer electrode 42. Pressing the ball portion BP against the transmissive member CP causes the insulating coating 50B remaining on the ball portion BP to stick to the transmissive member CP.

Next, the second-end bonding step S22 is performed. In the second-end bonding step S22, as illustrated in FIG. 13, the ball portion BP is irradiated with a laser beam from the side of the transmissive member CP while the ball portion BP is held between the transmissive member CP and the second outer electrode 42. In this state, the ball portion BP is in contact with the second outer electrode 42. The second bonded portion 51B is thereby formed at the second end of the wire 50 and joined to the second outer electrode 42. The ball portion BP is buried in a melted or softened portion of the third layer L3 due to the pressing force of the transmissive member CP, thereby forming the buried portion 54. The pressing force of the transmissive member CP flattens a surface of the second bonded portion 51B, the surface facing in the first positive direction X1.

Next, the second-end removal step S23 is performed. In the second-end removal step S23, the transmissive member CP is removed from the wire 50. In the second-end removal step S23, the residual insulating coating 50B remaining on the ball portion BP is removed from the wire 50 together with the transmissive member CP.

### Advantageous Effects of Present Embodiment

(1) In the above embodiment, the thickness of each bonded portion 51 of the wire 50 is greater than the diameter of the body portion 52. Accordingly, the wire 50 does not break easily at the boundary portion between each bonded portion 51 and the body portion 52 even if an external force acts more or less on the bonded portion 51.

(2) In the above embodiment, the first length A1 is greater than the diameter of the body portion 52. This can increase the area of contact between the bonded portion 51 and the outer electrode 40. This can reduce the likelihood of the wire 50 coming off the outer electrode 40.

(3) In the above embodiment, the second length A2 is smaller than the first length A1. Accordingly, in the specific cross section, the buried portion 54 includes a portion of which the length along the second axis Y becomes smaller as it proceeds in the first positive direction X1. In other words, the bonded portion 51 has a portion covered by the outer electrode 40. This reduces the likelihood of the bonded portion 51 coming off the outer electrode 40.

(4) In the above embodiment, the wire 50 includes the conductor 50A and the insulating coating 50B. In addition, each bonded portion 51 includes the conductor 50A only. This reduces the likelihood of the insulating coating 50B interfering with the electric connection between the bonded portion 51 and the outer electrode 40.

(5) In the above embodiment, the provisional fixation portion 53 includes the conductor 50A and the insulating coating 50B. Accordingly, in the provisional fixation portion 53, the conductor 50A does not come into direct contact with the outer electrode 40. This can reduce the likelihood of the conductor 50A being leached into the outer electrode 40 and becoming thinner.

(6) In the above embodiment, the end of each bonded portion 51 facing in the first negative direction X2 is positioned further in the first positive direction X1 from the end of the second layer L2 facing in the first positive direction X1. In other words, the bonded portion 51 does not reach the interface between the third layer L3 and the second layer L2. If, for example, the bonded portion 51 reaches the interface between the third layer L3 and the second layer L2 in the second-end pressing step S21, the bonded portion 51 may receive a reaction force at the interface. As a result, an excessive external force may be applied to the bonded portion 51. With this configuration, however, the likelihood of an external force applying to the bonded portion 51 can be reduced.

(7) In the above embodiment, the third layer L3 contains tin (Sn). The tin is a relatively soft metal. Accordingly, the third layer L3 containing the tin can reduce the external force acting on the bonded portion 51 when the bonded portion 51 is bonded to the outer electrode 40.

(8) In the above embodiment, the body portion 52 has the provisional fixation portion 53 bonded to the third layer L3. The third layer L3 contains the tin. Accordingly, the melting point of the third layer L3 is relatively low, and the third layer L3 is melted easily by the laser beam. Accordingly, the provisional fixation portion 53 can be formed simply by pressing the body portion 52 against the melted third layer L3 in the second-end provisional fixation step S18. The provisional fixation portion 53 prevents the wire 50 from being displaced easily during the formation of the second bonded portion 51B.

(9) In the above embodiment, the end surface of each bonded portion 51 facing in the first positive direction X1 is the surface extending parallel to the second axis Y and the central axis C. This can stabilize the position of the coil component 10 when the coil component 10 is, for example, soldered to a circuit board.

(10) In the above embodiment, the method of bonding the wire 50 includes the second-end ball forming step S20 and the second-end bonding step S22. In addition, the method of bonding the wire 50 includes the second-end pressing step S21 to be performed after the second-end ball forming step S20 and before the second-end bonding step S22. Performing the second-end pressing step S21 enables the ball portion BP to be buried deeply into the second outer electrode 42. The same applies to the first-end pressing step S13.

(11) In the above embodiment, the wire 50 has the conductor 50A and the insulating coating 50B before the second-end ball forming step S20 is performed. The method of bonding the wire 50 includes the second-end removal step S23 to be performed before the second-end bonding step S22. In the second-end removal step S23, the residual insulating coating 50B remaining on the ball portion BP is removed from the wire 50 together with the transmissive member CP. Performing the second-end removal step S23 exposes the conductor 50A from the surface of the second bonded portion 51B facing in the first positive direction X1. This improves the solder wettability of the second outer electrode 42 when the second outer electrode 42 is, for example, soldered to a circuit board compared with the case in which the insulating coating 50B is present on the surface of the second bonded portion 51B facing in the first positive direction X1. The same applies to the first-end removal step S15.

(12) In the above embodiment, the insulating coating 50B is adhered to only a portion of the transmissive member CP in the first-end pressing step S13 and in the second-end pressing step S21. A portion of the transmissive member CP to which the insulating coating 50B is not adhered can be used in the bonding step of the wire 50, which enables the same transmissive member CP to be reused. The reuse of the transmissive member CP, without throwing away each time, leads to a reduction in the cost increase for the above steps.

(13) In the above embodiment, the third layer L3 of each outer electrode 40 contains tin (Sn). The conductor 50A contains copper (Cu). In other words, each bonded portion 51 contains copper (Cu). As a result, Cu—Sn alloy can be formed in the boundary portion between the bonded portion 51 and the outer electrode 40. The formation of the Cu—Sn alloy in the boundary portion stabilizes the electrical characteristics of the bonded portion 51.

### Modification Example

The above embodiment and modifications described below can be combined with one another insofar as the combination does not pose any technical contradiction.

The structure of the coil component 10 is not limited to what has been described in the above embodiment. For example, the coil component 10 does not need to have the top plate 12. The winding core 11 does not need to be the quadrangular prism. For example, the cross section of the winding core 11 can be shaped like a circle, an oval, or a polygon other than a rectangle.

The diameter of the body portion 52 of the wire 50 is not limited to what has been described in the above embodiment. It is sufficient that the length P1, which extends along the first axis X between the end of the bonded portion 51 facing in the first negative direction X2 and the end of the bonded portion 51 facing in the first positive direction X1, be greater than the diameter of the body portion 52.

The layered structure of each outer electrode 40 is not limited to what has been described in the above embodiment. It is sufficient that the outer electrode 40 include at least one conductive layer. In this case, the one conductive layer serves as the outermost layer. The material of each layer of the outer electrode 40 is not limited to what has been described in the above embodiment.

The end of the bonded portion 51 facing in the first negative direction X2 may be positioned further in the first negative direction X2 from the end of the second layer L2 facing in the first positive direction X1. In other words, the end of the bonded portion 51 facing in the first negative direction X2 may be positioned further in the first negative direction X2 from the end of the inner layer facing in the first positive direction X1.

The bonded portion 51 may include the insulating coating 50B in addition to the conductor 50A. It is sufficient that the bonded portion 51 be electrically connected to the outer electrode 40. In the specific cross section, the first length A1 does not need to be the maximum length of the buried portion 54 along the second axis Y. In the specific cross section, the first length A1 may be a length of the buried portion 54 along the second axis Y, the length being taken at any position along the first axis X. When the second length A2 is defined as the length of a portion of the buried portion 54 along the second axis Y at a position further in the first positive direction X1 from where the first length A1 is taken, the advantageous effect described in (3) above can be obtained insofar as the second length A2 is smaller than the first length A1.

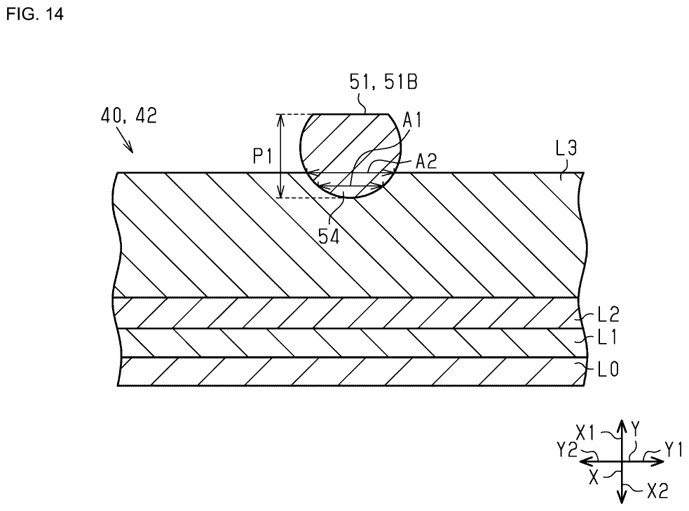

The bonded portion 51 does not need to be buried entirely in the outer electrode 40. It is sufficient that at least part of the bonded portion 51 be buried in the outer electrode 40. In the specific cross section, as illustrated in the example of FIG. 14, the end of the bonded portion 51 facing in the first negative direction X2 is positioned further in the first negative direction X2 from the end of the outer electrode 40 facing in the first positive direction X1. On the other hand, in the specific cross section, the end of the bonded portion 51 facing in the first positive direction X1 is positioned further in the first positive direction X1 from the end of the outer electrode 40 facing in the first positive direction X1. Accordingly, also in the example of FIG. 14, in the specific cross section, the length P1 along the first axis X between the end of the bonded portion 51 facing in the first positive direction X1 and the end of the bonded portion 51 facing in the first negative direction X2 is greater than the diameter of the body portion 52. In the example of FIG. 14, the second length A2 is greater than the first length A1. In the example of FIG. 14, a maximum length of the buried portion 54 along the second axis Y is smaller than the diameter of the body portion 52 in the specific cross section.

The body portion 52 does not need to include the provisional fixation portion 53 insofar as each bonded portion 51 is coupled to the outer electrode 40. In this case, the method of bonding the wire 50 does not need to include the second-end provisional pressing step S17 and the second-end provisional fixation step S18.

In the method of bonding the wire 50, the first-end pressing step S13, the first-end removal step S15, the second-end pressing step S21, and the second-end removal step S23 can be omitted. In other words, the transmissive member CP is not necessarily used in the method of bonding the wire 50 insofar as the bonded portion 51 is coupled to the outer electrode 40.

The method of manufacturing the coil component is not limited to the example described in the above embodiment. For example, the winding step S16 may be performed immediately after the preparation step S11, and the first-end ball forming step S12 and the first-end bonding step S14 may be performed thereafter.

### Supplementary Note

Technical ideas derived from the above embodiment and the modifications are listed as follows.

[1] A coil component includes a core that includes a column-like winding core having a central axis and a pair of flanges joined to respective opposite ends of the winding core in an axial direction of the winding core; a wire wound around the winding core; and an outer electrode that covers an outer surface of each flange of the pair of flanges. A first axis is defined as an axis orthogonally intersecting the central axis. A positive direction is defined as a direction directed toward one side along the first axis, and a negative direction is defined as the direction directed oppositely to the positive direction. Each flange projects outward in the positive direction from an outer surface of the winding core. The outer electrode covers the outer surface of each flange facing in the positive direction. The wire includes a body portion wound around the winding core and a bonded portion positioned at each end of the wire and coupled to the outer electrode. A cross section of each flange is taken so as to orthogonally intersect the central axis and to include the bonded portion. In the cross section, an end of the bonded portion facing in the negative direction is positioned further in the negative direction from an end of the outer electrode facing in the positive direction. In the cross section, a length along the first axis between the end of the bonded portion facing in the negative direction and an end of the bonded portion facing in the positive direction is greater than a diameter of the body portion.

[2] In the coil component described in [1] above, a second axis is defined as an axis that orthogonally intersects both the central axis and the first axis, and in the cross section, a buried portion is defined as a portion of the bonded portion that is positioned further in the negative direction from the end of the outer electrode facing in the positive direction. In this case, the maximum length of the buried portion along the second axis in the cross section is greater than the diameter of the body portion.

[3] In the coil component described in [1] or [2] above, a second axis is defined as an axis that orthogonally intersects both the central axis and the first axis, and in the cross section, a buried portion is defined as a portion of the bonded portion that is positioned further in the negative direction from the end of the outer electrode facing in the positive direction. In addition, a first length is defined as a length of the buried portion along the second axis, the length being taken at an arbitrary position along the first axis, and a second length is defined as a length of the buried portion along the second axis, the length being taken at a position further in the positive direction from where the first length is taken. In this case, the second length is smaller than the first length.

[4] In the coil component described in any one of [1] to [3] above, the wire includes an elongated conductor and an insulating coating covering a peripheral surface of the conductor. In addition, the body portion includes the conductor and the insulating coating, and the bonded portion includes the conductor only.

[5] In the coil component described in any one of [1] to [4] above, the outer electrode includes an inner layer and an outer layer positioned further than the inner layer from the outer surface of each flange, and in the cross section, the end of the bonded portion facing in the negative direction is positioned further in the positive direction from an end of the inner layer facing in the positive direction.

[6] In the coil component described in any one of [1] to [5] above, the outer electrode includes an outermost layer among layers of the outer electrode, and the outermost layer contains tin (Sn).

[7] In the coil component described in [6] above, the body portion includes a provisional fixation portion bonded to the outermost layer.

[8] A method of bonding a wire includes a ball forming step of forming a ball portion by melting the wire at each end of the wire, the ball portion having a diameter greater than that of a body portion of the wire before melting the wire; and a bonding step of forming a bonded portion at each end of the wire, the bonded portion being bonded to an outer electrode that covers an outer surface of a core, in such a manner that the ball portion is irradiated with a laser beam while the ball portion is in contact with the outer electrode.

[9] The method of bonding the wire described in [8] above further includes a pressing step of pressing the ball portion against the outer electrode in such a manner that the ball portion is pressed between the outer electrode and a transmissive member made of a laser-transmissive material, the pressing step being performed after the ball forming step and before the bonding step. In the bonding step, the ball portion is irradiated with the laser beam from a side of the transmissive member while the ball portion is pressed between the outer electrode and the transmissive member.

[10] In the method of bonding the wire described in [9] above, the wire includes an elongated conductor and an insulating coating covering a peripheral surface of the conductor before the ball forming step is performed, and the method further includes a removal step of removing a residue of the insulating coating in the ball portion from the wire by removing the transmissive member from the wire.

[11] A method of manufacturing a coil component includes a preparation step of preparing a core that includes a column-like winding core having a central axis, a pair of flanges joined to respective opposite ends of the winding core in an axial direction of the winding core, and an outer electrode that covers an outer surface of each flange of the pair of flanges; a winding step of winding a wire around the winding core; a ball forming step of forming a ball portion by melting the wire at each end of the wire, the ball portion having a diameter greater than that of a body portion of the wire before melting the wire; and a bonding step of forming a bonded portion at each end of the wire, the bonded portion being bonded to an outer electrode, in such a manner that the ball portion is irradiated with a laser beam while the ball portion is in contact with the outer electrode.

[12] The method of manufacturing the coil component described in [11] above further includes a pressing step of pressing the ball portion against the outer electrode in such a manner that the ball portion is pressed between the outer electrode and a transmissive member made of a laser-transmissive material, the pressing step being performed after the ball forming step and before the bonding step. In the bonding step, the ball portion is irradiated with the laser beam from a side of the transmissive member while the ball portion is pressed between the outer electrode and the transmissive member.

[13] In the method of manufacturing the coil component described in [12] above, the wire includes an elongated conductor and an insulating coating covering a peripheral surface of the conductor before the ball forming step is performed, and the method further includes a removal step of removing a residue of the insulating coating in the ball portion from the wire by removing the transmissive member from the wire.

[14] In the method of manufacturing the coil component described in any one of [11] to [13] above, the outer electrode includes an outermost layer among layers of the outer electrode, the outermost layer containing tin (Sn), and the method further includes a provisional fixation step of bonding a provisional fixation portion of the wire to a provisional fixation area of the outer electrode in such a manner that the provisional fixation area is irradiated with the laser beam at a position closer than a later bonded portion of the wire to the winding core, the provisional fixation step being performed before the ball forming step.

What is claimed is:

1. A coil component comprising:
a core that includes a column-like winding core having a central axis and a pair of flanges joined to respective opposite ends of the winding core in an axial direction of the winding core;
a wire wound around the winding core; and
an outer electrode that covers an outer surface of each flange of the pair of flanges, wherein
a first axis is defined as an axis orthogonally intersecting the central axis,
a positive direction is defined as a direction directed toward one side along the first axis, and a negative direction is defined as the direction directed opposite to the positive direction,
each flange projects outward in the positive direction from an outer surface of the winding core,
the outer electrode covers the outer surface of each flange facing in the positive direction,
the wire includes a body portion wound around the winding core and a bonded portion at each end of the wire and connected to the outer electrode,
a cross section of each flange orthogonally intersects the central axis and to include the bonded portion,
in the cross section, an end of the bonded portion facing in the negative direction is located further in the negative direction with respect to an end of the outer electrode facing in the positive direction, and
in the cross section, a length of the bonded portion along the first axis between the end of the bonded portion facing in the negative direction and an end of the bonded portion facing in the positive direction is greater than a diameter of the body portion of the wire.

2. The coil component according to claim 1, wherein
a second axis is defined as an axis that orthogonally intersects both the central axis and the first axis, and
in the cross section, a buried portion is defined as a portion of the bonded portion that is located further in the negative direction with respect to the end of the outer electrode facing in the positive direction, and
a maximum length of the buried portion along the second axis in the cross section is greater than the diameter of the body portion of the wire.

3. The coil component according to claim 1, wherein
a second axis is defined as an axis that orthogonally intersects both the central axis and the first axis,
in the cross section, a buried portion is defined as a portion of the bonded portion that is located further in the negative direction with respect to the end of the outer electrode facing in the positive direction,
a first length is defined as a length of the buried portion in the direction of the second axis, the first length being measured at an arbitrary position along the first axis,
a second length is defined as a length of the buried portion in the direction of the second axis, the second length being measured at a position further in the positive direction with respect to a position where the first length is measured, and
the second length is smaller than the first length.

4. The coil component according to claim 1, wherein
the wire includes an elongated conductor and an insulating coating covering a peripheral surface of the conductor,
the body portion includes the conductor and the insulating coating, and
the bonded portion includes the conductor only.

5. The coil component according to claim 1, wherein
the outer electrode includes an inner layer and an outer layer opposite to the outer surface of each flange with respect to the inner layer, and
in the cross section, the end of the bonded portion facing in the negative direction is located further in the positive direction with respect to an end of the inner layer facing in the positive direction.

6. The coil component according to claim 1, wherein
the outer electrode includes an outermost layer among layers of the outer electrode, and
the outermost layer includes tin.

7. The coil component according to claim 6, wherein
the body portion includes a provisional fixation portion bonded to the outermost layer.

8. A method of bonding a wire, comprising:
forming a ball portion by melting the wire at each end of the wire, the ball portion having a diameter greater than a diameter of a body portion of the wire before melting the wire; and
forming a bonded portion at each end of the wire, the bonded portion being bonded to an outer electrode that covers an outer surface of a core, in such a manner that the ball portion is irradiated with a laser beam while the ball portion is in contact with the outer electrode.

9. The method of bonding the wire according to claim 8, the method further comprising:
pressing the ball portion against the outer electrode in such a manner that the ball portion is sandwiched between the outer electrode and a transmissive member made of a laser-transmissive material, the pressing being performed after the forming of the ball portion and before the forming of the bonded portion, wherein
in the forming of the bonded portion, the ball portion is irradiated with the laser beam from a side of the transmissive member while the ball portion is sandwiched between the outer electrode and the transmissive member.

10. The method of bonding the wire according to claim 9, wherein
the wire includes an elongated conductor and an insulating coating covering a peripheral surface of the conductor before the forming of the ball portion is performed, and
after the forming of the bonded portion, the method further comprises removing the transmissive member from the wire together with a residue of the insulating coating remaining in the ball portion.

11. A method of manufacturing a coil component, the method comprising:
preparing a core that includes
a column-like winding core having a central axis,
a pair of flanges joined to respective opposite ends of the winding core in an axial direction of the winding core, and
an outer electrode that covers an outer surface of each flange of the pair of flanges;
winding a wire around the winding core;
forming a ball portion by melting the wire at each end of the wire, the ball portion having a diameter greater than that of a body portion of the wire before melting the wire; and
forming a bonded portion at each end of the wire, the bonded portion being bonded to an outer electrode, in such a manner that the ball portion is irradiated with a laser beam while the ball portion is in contact with the outer electrode.

12. The method of manufacturing the coil component according to claim 11, further comprising:
pressing the ball portion against the outer electrode in such a manner that the ball portion is sandwiched between the outer electrode and a transmissive member made of a laser-transmissive material, the pressing being performed after the forming of the ball portion and before the forming of the bonded portion, wherein
in the forming of the bonded portion, the ball portion is irradiated with the laser beam from a side of the transmissive member while the ball portion is sandwiched between the outer electrode and the transmissive member.

13. The method of manufacturing the coil component according to claim 12, wherein
the wire includes an elongated conductor and an insulating coating covering a peripheral surface of the conductor before the forming of the ball portion is performed, and
after the forming of the bonded portion, the method further comprises removing the transmissive member from the wire together with a residue of the insulating coating remaining in the ball portion.

14. The method of manufacturing the coil component according to claim 11, wherein
the outer electrode includes an outermost layer among layers of the outer electrode, the outermost layer including tin, and
before the forming of the ball portion, the method further comprises bonding a provisional fixation portion of the wire at a winding core side, which is located at a position closer to the winding core side than a position where a bonded portion of the wire is to be formed, to a provisional fixation area of the outer electrode in such a manner that the provisional fixation area of the outer electrode is irradiated with the laser beam.
